(19) United States
(12) Patent Application Publication
(10) Pub. No.: US 2014/0337050 A1
(43) Pub. Date: Nov. 13, 2014

(54) GRAPHICALLY DISPLAYING FAMILY MEDICAL CONDITIONS FOR A PATIENT

(71) Applicant: SETH MICHEL CLAYBROOK, LEE'S SUMMIT, MO (US)

(72) Inventor: SETH MICHEL CLAYBROOK, LEE'S SUMMIT, MO (US)

(73) Assignee: CERNER INNOVATION, INC., Lenexa, KS (US)

(21) Appl. No.: 13/891,635

(22) Filed: May 10, 2013

(51) Int. Cl. G06F 19/00

(52) U.S. Cl. CPC G06F 19/3431
USPC 705/3

(57) ABSTRACT

Methods, systems, and computer-storage media are directed at determining one or more medical conditions of a patient, based on a family tree of the patient. The family tree of the patient incorporates one or more medical conditions of family members and non-biological persons in contact with the patient. A graphical representation of the family tree is displayed on a graphical user interface (GUI) of a computing system, along with a list of medical conditions suffered by the individual persons within the family tree of the patient. A user can select one or more medical conditions from the list, and based on the selection, those family tree members suffering from the one or more selected medical conditions are then highlighted within the graphical representation of the family tree.

### BACKGROUND

In the health care industry, there is a desire to preemptively determine the undesirable medical conditions for a patient. One method of accomplishing this goal is for a clinician to examine the medical conditions of biological family members in order to assess the likelihood of the patient developing or obtaining those same medical condition(s) found among the biological family members.

Similarly, non-biological persons that are in contact with the patient, such as adopted persons, persons living with the patient, step-siblings, step-children and step-parents of the patient, can all contribute to the overall health of the patient. Thus, a clinician should also examine the medical conditions of non-biological persons that are in contact with the patient, in addition to biological family members.

Currently, clinicians are generally given the medical conditions of biological family members and non-biological persons that are in contact with the patient through oral communication from the patient. Unfortunately, this can lead to partial or incorrect information regarding the medical conditions of biological family members and non-biological persons that are in contact with the patient.

### BRIEF SUMMARY

Systems and methods are implemented that facilitate the use of preemptive determination of the potential for a patient to obtain undesirable medical conditions. In this way, incidents of undesirable medical conditions may be reduced and patient safety improved.

In one embodiment, a method in a computing system provides for the determining of one or more medical conditions of a patient, based on a family tree of the patient. The method includes receiving a selection of the patient within the family tree of the patient, wherein the family tree of the patient incorporates one or more medical conditions of family members and non-biological persons in contact with the patient. It is then determined whether there are medical conditions among the individual persons within the family tree of the patient. Subsequently, any medical conditions revealed are then consolidated into a list of medical conditions suffered by the individual persons within the family tree of the patient. The list is then displayed on the computing system. Along with the list of medical conditions, a graphical representation of the family tree is also displayed on the computing system. A user can then select one or more medical conditions from the list. Based on this selection, the family tree members that are suffering from the one or more selected medical conditions are highlighted within the graphical representation of the family tree.

In yet another aspect, a computing device with a graphical user interface (GUI) provides a visual representation of the relationship among one or more medical conditions found within a family tree of a patient. The GUI allows for the graphical representation of the family tree of the patient and a selectable list of the one or more medical conditions found within the family tree. A user can select one or more medical conditions within the list and this will result in the highlighting of the corresponding members within the family tree that suffer from the selected medical condition.

In another embodiment, a system is made up of a generating component that generates a family tree of the patient, a labeling component that labels one or more members of the family tree of the patient with one or more medical conditions suffered by the corresponding members, a verification component that verifies that the one or more medical conditions suffered by the one or more members of the family tree are the most up-to-date medical conditions of those family tree members, a storage component that stores the one or more medical conditions suffered by the one or more members of the family tree in a patient's EMR and a displaying component that displays the one or more medical conditions suffered by the one or more members of the family tree on a graphical user interface (GUI).

Additional advantages and novel features of embodiments of the invention will be set forth in part in a description which follows, and in part will become apparent to those skilled in the art upon examination of the following, or may be learned by practice of the invention.

### BRIEF DESCRIPTION OF THE FIGURES

Embodiments are described in detail below with reference to the attached drawing figures, wherein:

FIG. 1 is a schematic diagram of a suitable computing system environment for use in implementing the present invention;

FIG. 2 is a block diagram of an exemplary system for, among other things, generating and displaying a family tree of a patient;

FIG. 3 is a flow diagram illustrating one method for providing medical conditions within a family tree of a patient that is displayed on a graphical user interface;

FIGS. 4-7 depict a visual representation of the family tree analyzer window.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to methods, systems, and computer-storage media for presenting graphical representations of time-ordered audit events. The time-ordered audit events may represent instances where electronic records associated with one or more parties have been accessed by a party-of-interest during a specified time frame. As mentioned, the term “party-of-interest” refers to a person employed or associated with a facility maintaining an audit log and who has access rights to electronic records kept by the facility. Exemplary parties-of-interest include clinicians, bank officers, administrators, teachers, and the like. The term “party” refers to an entity who receives services provided by the facility. As such, the party may refer to a customer, a patient, a student, and the like. The electronic records may include financial records, educational records, health records, insurance records, and the like.

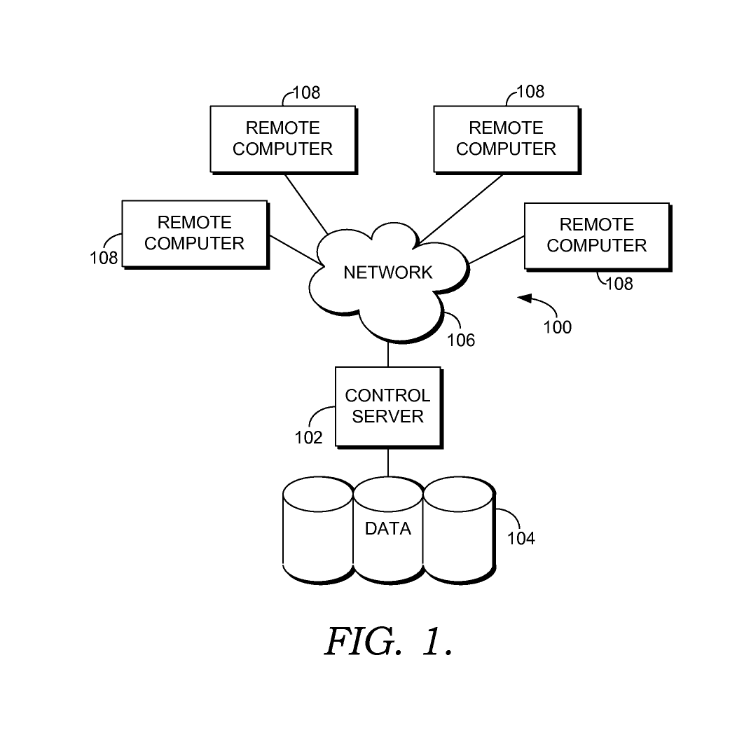

An exemplary computing environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention might be operational with numerous other purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of non-transitory computer-readable media. Computer-readable media can be any available media that might be accessed by control server 102, and includes volatile and nonvolatile media, as well as, removable and nonremovable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and clinicians' offices. Clinicians may comprise a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization might enter commands and information into the control server 102 or convey the commands and information to the control server 102 via one or more of the remote computers 108 through input devices, such as a keyboard, a pointing device (commonly referred to as a mouse), a trackball, or a touch pad. Other input devices comprise microphones, satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

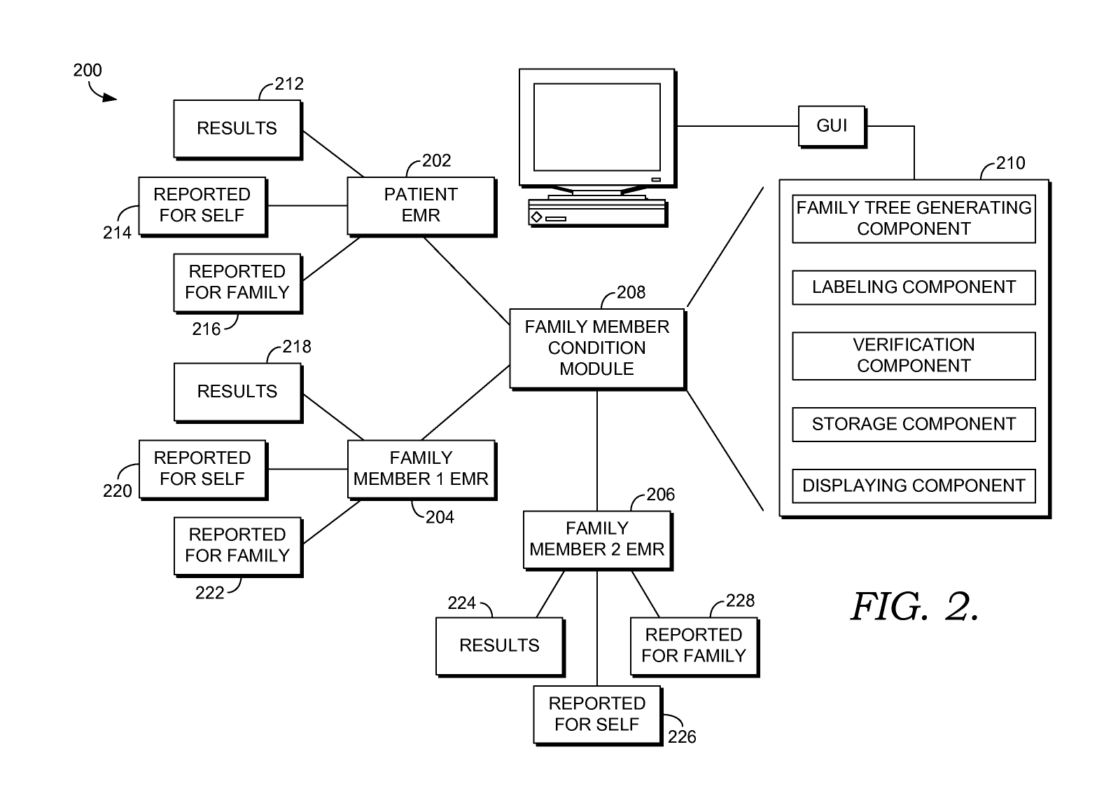

Turning now to FIG. 2, the family tree analyzer system 200 is capable of communicating with a number of different data sources, such as the patient's electronic medical record (EMR) information 202 and the one or more family tree member's EMR information 204 and 206. As used throughout this application, the term “electronic medical record (EMR) information” is meant to be broad and encompass many types of healthcare information found in a healthcare environment. For example, EMR information may include such information like lab or medical test results for the patient 212 and for the family tree members 218 and 224. The EMR information may also include medical conditions of the patient that have been reported by the patient themselves 214. Similarly, the EMR information may include medical conditions of the family tree members that have been reported by themselves 220 and 226. The EMR information may also include medical conditions of family tree members that have been reported by the patient 216, medical conditions of the patient that have been reported by other family tree members 222 and 228, and medical conditions of family tree members reported by other family tree members 222 and 228.

The Family Member Condition Module 208 and 210 acts as a receiving component of the EMRs of the patient and the family tree members. The Family Member Condition Module 208 and 210 includes computer system components that aid in generating the family tree data and displaying this data to a clinician. In particular, the computer system of the Family Member Condition Module includes a generating component that generates a family tree of the patient, a labeling component that labels one or more members of the family tree of the patient with one or more medical conditions suffered by the corresponding members, a verification component that verifies that the one or more medical conditions suffered by the one or more members of the family tree are the most up-to-date medical conditions of those family tree members, a storage component that stores the one or more medical conditions of the one or more members of the family tree in a patient's EMR and a displaying component that displays the one or more medical conditions suffered by the one or more members of the family tree on a graphical user interface (GUI). A family tree comprises related individuals to the patient, which includes both biological family members and non-biological persons in contact with the patient. Non-biological persons in contact with the patient can include adopted persons, persons living with the patient, step-siblings, step-children, step-parents, and the like. Related individuals, also referred to as family tree members, are then identified as being related to the patient and are included in the family tree of the patient.

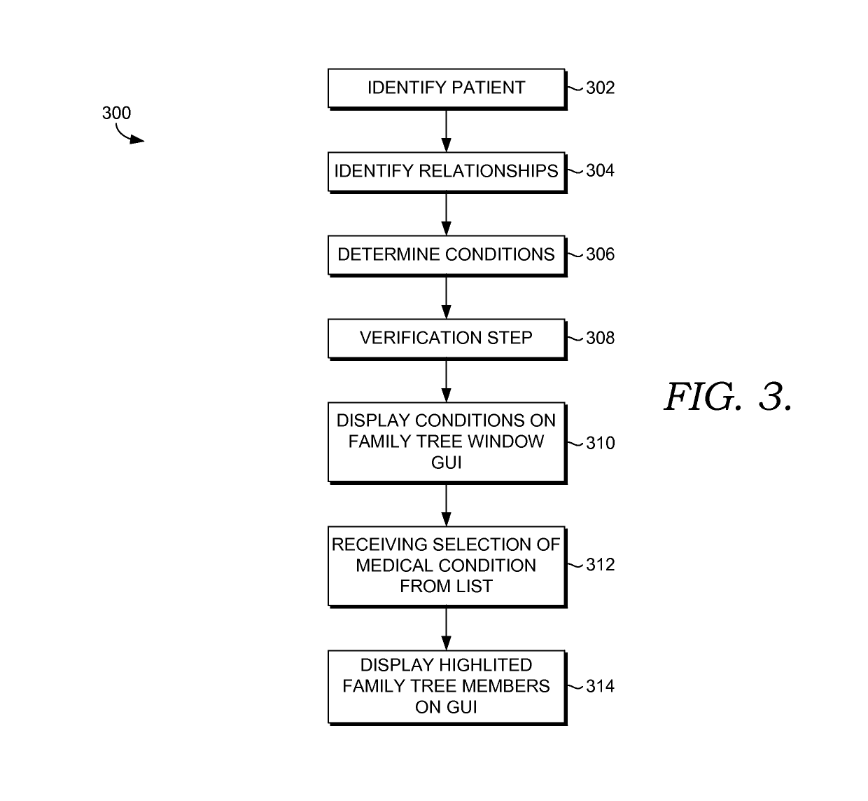

Turning now to FIG. 3, a flow diagram is shown of an exemplary method 300 of displaying, on a graphical user interface (GUI), medical conditions within a family tree of a patient. Types of medical conditions are numerous, but representative examples may include hypertension, cancer, diabetes, gastroesophageal reflux disease (GERD), seizures, cardiac arrest, and the like. At a step 302, the electronic medical record (EMR) of a patient is retrieved.

At a step 304, the patient's EMR is accessed to determine related individuals, who should be included in the family tree of the patient. Related individuals can include both biological family members and non-biological persons in contact with the patient. Non-biological persons in contact with the patient can include adopted persons, persons living with the patient, step-siblings, step-children, step-parents, and the like. Related individuals, also referred to as family tree members, are then identified as being related to the patient and are included in the family tree of the patient. Once family tree members are identified, a family tree of the patient can be assembled. Alternatively, a family tree of the patient might already be assembled. Once the family tree members of the patient are identified, medical conditions of the family tree members are determined 306 through accessing their EMRs, through oral communication from the patient, and/or through oral communication from one or more family tree members. Next, a verification step 308 determines which medical condition information overrides other medical condition information. For example, in one embodiment, the patient orally reports that his or her paternal grandfather does not suffer from hypertension. However, medical results found in the paternal grandfather's EMR indicate that he does suffer from hypertension. In this case, the verification step would report the paternal grandfather as suffering from hypertension, and thereby overriding the oral report given by the patient. In embodiments, the verification step would ensure that any lab or medical test results would override any oral reports.

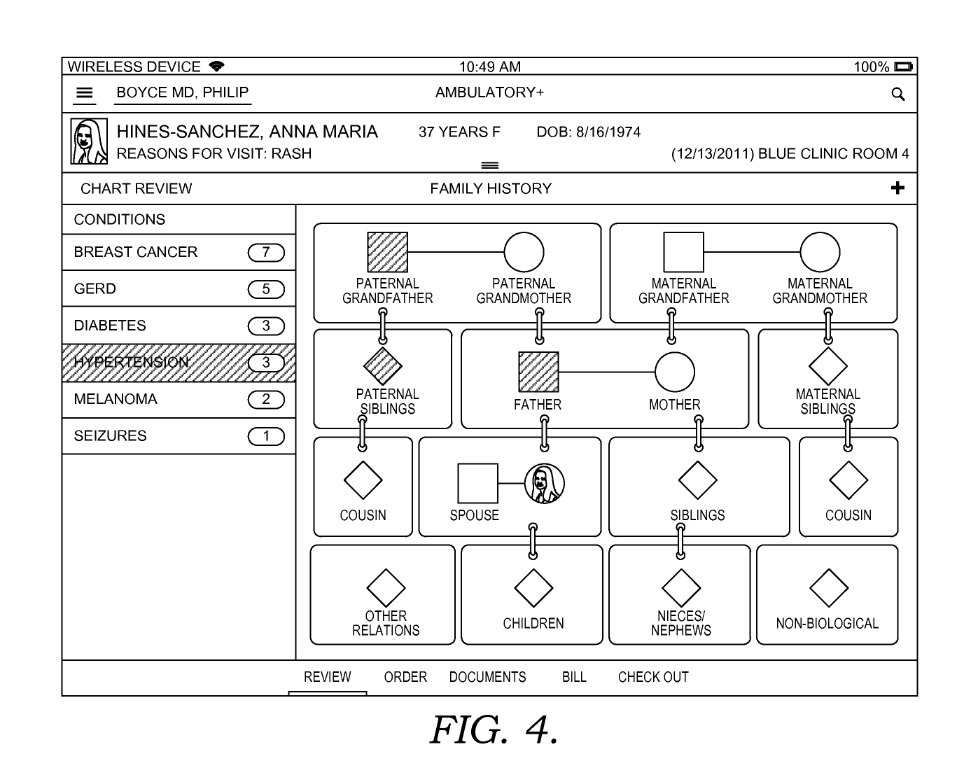

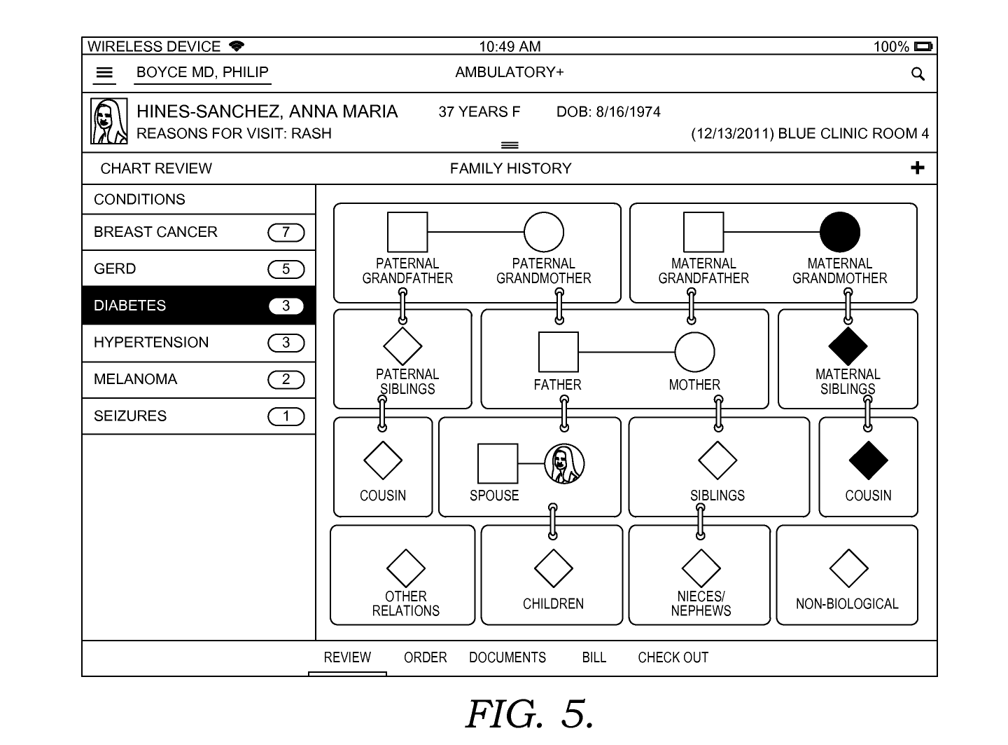

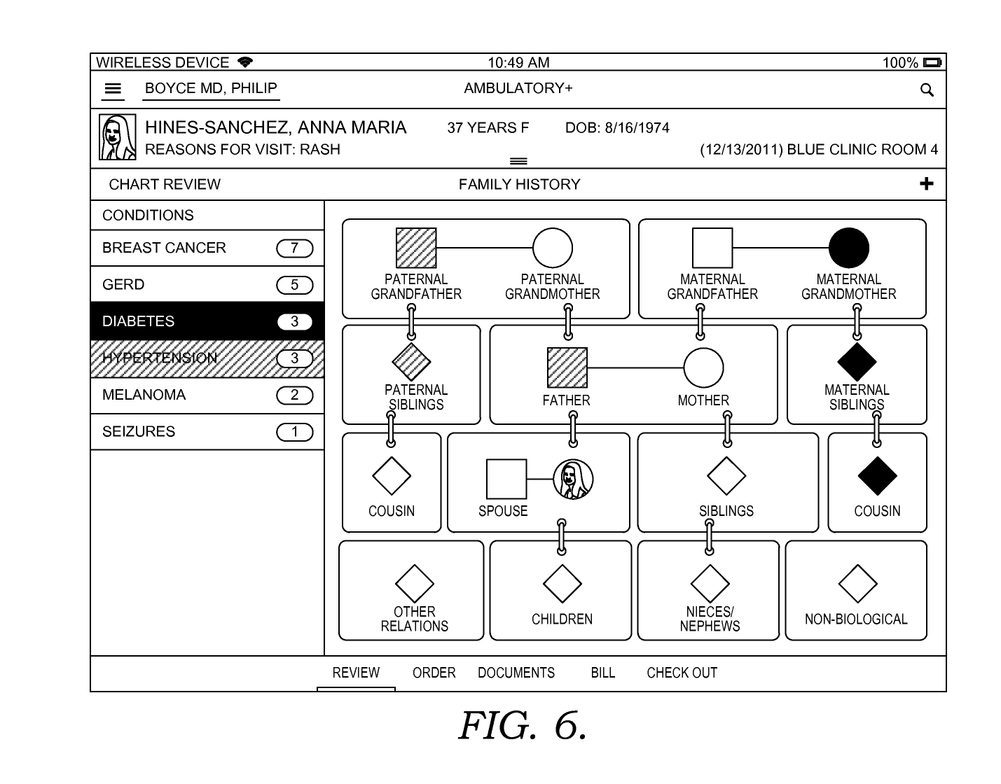

At a step 310, medical conditions of family tree members are displayed on a graphical user interface (GUI). In particular, a graphical representation of the family tree is displayed in a family tree window, as illustrated in FIG. 4. A family tree window comprises a graphical representation of the family tree of the patient, a list of the medical conditions suffered by the family tree members, along with other pertinent information, as illustrated in FIG. 4. Pertinent information can include the name of the patient, the gender of the patient, the age of the patient, the date of birth of the patient, the date, and the like. Displaying the medical conditions of the family tree members on the graphical representation of the family tree starts with identifying the patient within the family tree. This might be accomplished by including a picture of the patient within the family tree, as illustrated in FIG. 4. Next, relationships to the patient are identified within the family tree, also illustrated in FIG. 4. Along with a graphical display of the family tree, a list of medical conditions suffered by members of the family tree is displayed. Within the list of medical conditions is the number of members of the family tree that suffer from that particular medical condition, as illustrated in FIG. 4. When a medical condition is selected from the list, the corresponding members of the family tree that suffer from that particular medical condition become highlighted. In one embodiment, one or more medical conditions from the list can be selected 312. In this case, the one or more family tree members suffering from the selected medical conditions become highlighted within the graphical representation of the family tree 314. For example, if the father, paternal siblings and paternal grandfather of the patient all suffer from hypertension, clicking the hypertension link within the list would result in the highlighting of those family tree members, as illustrated in FIG. 4. In another example, if the maternal grandmother, maternal siblings and maternal cousin of the patient all suffer from diabetes, clicking the diabetes link within the list would result in the highlighting of those family tree members, as illustrated in FIG. 5. In yet another example, if both the hypertension link and the diabetes link were clicked in these examples, all six family tree members would become highlighted, as illustrated in FIG. 6.

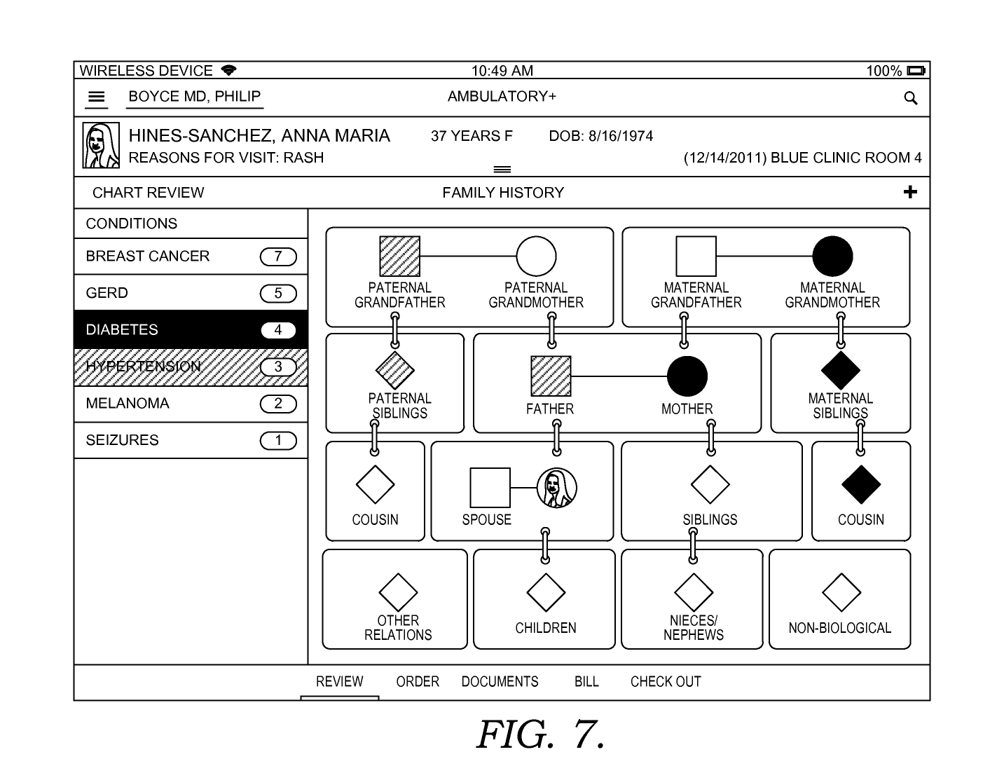

Turning now to FIG. 7, the family tree window always displays the most recent medical condition information. For example, early on the day of Dec. 13, 2011, the family tree window displays that the mother of the patient does not suffer from diabetes. Later that evening of Dec. 13, 2011, the mother of the patient undergoes medical tests that reveal that she does indeed suffer from diabetes. This medical condition information is entered into the mother's EMR on Dec. 13, 2011. The following day, Dec. 14, 2011, a clinician opens the family tree window. Now when the diabetes link within the list of medical conditions is selected, the graphical representation of the mother of the patient will become highlighted. Thus, the family tree window is updated as new medical condition information is entered into the EMR of family tree members.

The present invention has been described in relation to particular embodiments, which are intended in all respects to be illustrative rather than restrictive. Further, the present invention is not limited to these embodiments, but variations and modifications may be made without departing from the scope of the present invention.

What is claimed is:

1. A computerized method carried out by a family tree analyzer having at least one processor for determining one or more medical conditions of a patient, based on a family tree of the patient, the method comprising the steps of:
receiving a selection of the patient within the family tree of the patient, wherein the family tree of the patient comprises one or more medical conditions of family members and non-biological persons in contact with the patient;
determining, using the at least one processor, one or more medical conditions among one or more individual persons in the family tree of the patient;
consolidating the one or more medical conditions found among the individual persons in the family tree of the patient to construct a list of medical conditions;
displaying the list of the one or more medical conditions found among individual persons in the family tree of the patient;
displaying a graphical representation of the family tree of the patient;
receiving a selection of one or more medical conditions on the list;
as a result of receiving a selection of one or more medical conditions on the list, highlighting the one or more family members with the one or more medical conditions on the graphical representation of the family tree.

2. The method of claim 1, wherein determining whether the patient is at risk of obtaining the one or more medical conditions based on the family tree is determined by a clinician.

3. The method of claim 1, wherein the non-biological persons comprises adopted persons, persons living with the patient, step-siblings, step-children and step-parents of the patient.

4. The method of claim 1, wherein the highlighting of the one or more medical conditions on the list results in the highlighting of the family members with the one or more medical conditions on the graphical representation of the family tree.

5. The method of claim 4, wherein the highlighted portion of the family tree is colored a same color as the corresponding medical condition that is selected from the list.

6. The method of claim 1, wherein determining one or more medical conditions among one or more individual persons in the family tree of the patient is based on lab or medical test results.

7. The method of claim 1, wherein the determining one or more medical conditions among one or more individual persons in the family tree of the patient is based on oral communication by the patient.

8. The method of claim 1, wherein the determining one or more medical conditions among one or more individual persons in the family tree of the patient is based on oral communication by a family tree member.

9. The method of claim 1, wherein the displaying of a graphical representation of the family tree of the patient includes displaying a picture of the patient within the family tree.

10. One or more computer-storage media having computer-executable instructions embodied thereon that, when executed by a computing device, cause the computing device to generate a graphical user interface (GUI) for visually representing a relationship among one or more medical conditions found in a family tree of a patient, the GUI comprising:
a graphical representation of the family tree of the patient, wherein the family tree indicates the patient and the patient's relationship to family members and non-biological persons in contact with the patient;
a selectable list of one or more medical conditions found within the family tree;
one or more highlighted portions of the family tree corresponding to a user selecting the one or more medical conditions selected from the list.

11. The GUI of claim 10, wherein the highlighted portion of the family tree is colored a same color as the corresponding medical condition that is selected from the list.

12. The GUI of claim 10, wherein a number of family tree members suffering from a particular medical condition is displayed next to a corresponding medical condition within the selectable list.

13. A system for facilitating the exchange of information required to display an up-to-date family tree analyzer window, the system comprising:
a computing device having one or more processors and one or more computer-storage media associated with an electronic medical record (EMR) of a patient and one or more members of the patient's family tree, the computing device comprising:
a generating component that generates a family tree of the patient;
a labeling component that labels one or more members of the family tree of the patient with one or more medical conditions suffered by the corresponding one or more members;
a verification component that verifies that the one or more medical conditions suffered by the one or more members of the family tree are the most up-to-date medical conditions of the one or more members of the family tree;
a storage component that stores the one or more medical conditions suffered by the one or more members of the family tree in a patient's electronic medical record (EMR); and
a displaying component that displays the one or more medical conditions suffered by the one or more members of the family tree on a graphical user interface (GUI).

14. The system of claim 13, wherein the receiving component for the family tree member medical condition information is received orally from the patient.

15. The system of claim 13, wherein the receiving component for the patient medical condition information is received orally from the patient.

16. The system of claim 13, wherein the receiving component for the patient medical condition information is received from lab or medical test results.

17. The system of claim 13, wherein the receiving component is configured for receiving family tree member medical condition information, orally from an individual family tree member, wherein the individual family tree member is orally reporting medical condition information about themselves.

18. The system of claim 13, wherein the receiving component is configured for receiving family tree member medical condition information, orally from an individual family tree member, wherein the individual family tree member is orally reporting medical condition information about another family tree member.

19. The system of claim 13, wherein the receiving component is configured for receiving family tree member medical condition information from lab or medical test results.

20. The system of claim 13, wherein the verifying component is configured for verifying that lab or medical test results override any oral information from a family tree member.
